(19) United States
(12) Patent Application Publication
(10) Pub. No.: US 2009/0188586 A1
(43) Pub. Date: Jul. 30, 2009

(54) Method and apparatus for drum debarking of wood

(75) Inventor: Arvo Jonkka, Pori (FI)

Correspondence Address: BUCHANAN, INGERSOLL & ROONEY PC, POST OFFICE BOX 1404, ALEXANDRIA, VA, 22313-1404, US

(73) Assignee: Metso Paper, Inc., Helsinki (FI)

(21) Appl. No.: 10/585,349

(22) PCT Filed: Feb. 22, 2005
(86) PCT No.: PCT/FI2005/050044

§ 371 Date: Jul. 6, 2006

(30) Foreign Application Priority Data
Mar. 5, 2004 (FI) 20040360

(51) Int. Cl. B27L 1/04

(52) U.S. Cl. 144/341; 144/208.9

(57) ABSTRACT

The invention concerns a method and an apparatus for drum debarking of wood, the bark being removed from the wood in a debarking drum being rotatable alternatively in the opposite directions and having different debarking properties in the alternative directions of rotation thereof. According to the invention, the wood and the loosened bark along with it are guided to a bark separation dependent on the direction of rotation of the debarking drum.

The present invention concerns a method for debarking wood by means of a debarking drum being alternatively rotatable in opposite directions and having different debarking properties in said alternative rotation directions. More precisely, the invention concerns separating of wood and the loosened bark from the bark and wood flow discharged from a debarking drum.

In the pulp and paper industry, the logs are debarked prior to the chipping and the subsequent fibre separation processes. Depending on the pulp or paper quality to be produced, the bark must be removed from the wood quite completely. Normally, the debarking is effected by means of a suitable debarking drum, where the logs are debarked either with tumble debarking or parallel debarking. Debarking drums are equipped with bark slots, through which the most of the bark pieces loosened from the logs are removed from the wood flow. In some wood species used as raw material, like for example birch, the bark is firmly attached, whereby the bark loosens as bigger pieces in a late stage, and due to their big size they can't fall down through the bark slots. Especially many tropical wood species like green acacia and certain sorts of eucalyptus are problematic for drum debarking, because their typical long and. stringy bark usually loosens as big pieces, which are difficult to be removed through the narrow bark slots of the drum and are thus carried along to the infeed line of the chipper together with the wood.

An oversize widening of the bark slots is, however, not possible, because in that case also wood slats would be removed from the drum and the wood losses of the debarking process would be increased. To solve this problem, there is provided a debarking method in accordance with patent publication WO 03/106125, wherein the debarking drum includes no bark slots, and all the bark removed from the wood is separated from the wood flow on a roller conveyor subsequent to the debarking drum.

Also the infeed line of a chipper subsequent to a traditional debarking drum furnished with bark slots usually has a roller conveyor aimed at separating the rest removed bark pieces from the wood flow.

In tumble debarking the length of the drum is usually from 20 to 35 meters and the diameter from 4.5 to 5.5 meters. In parallel debarking the length of the drum is even longer, the diameter being, however, smaller.

The quality of the wood taken to the debarking varies, and often more than one sort of wood must be handled in one and the same debarking apparatus. For solving the problems caused by these facts for the debarking, there has been proposed a debarking drum being alternatively rotatable in opposite directions and being provided with different debarking properties in the opposite rotation directions. The basic structure of this kind of a debarking drum is disclosed for example in the Examined Patent Application Publication no 454 758 of the Swedish patent application no. 8401927-2.

Changes of the wood to be debarked and in the debarking efficiency cause also changes in the properties of the loosened bark following the wood from the debarking drum. Correspondingly, the devices separating the removed bark from the wood flow must operate in alternating conditions. The problem is emphasized in an apparatus, where drums with a substantially closed casing are used, and consequently practically all the bark follows the debarked wood from the drum. This problem exists also when using a debarking drum equipped at least for a part of its casing with bark removal slots.

An improvement to the problem has been provided by means of a method in accordance with the present invention, whereby the bark is removed from the log in a debarking drum being rotatable alternatively in opposite directions and having in its alternative rotation directions different debarking properties, by applying method steps having characteristics defined in the characterizing part of claim 1. Alternative embodiments of the invention are disclosed in the dependent claims 2 and 3.

An apparatus according to the invention for debarking logs is defined in the enclosed claim 4, including its own characteristics. Alternative embodiments of the apparatus in accordance with the invention are disclosed in the dependent claims from 5 to 7.

The invention and its details will be described in more detail in the following, with reference to the enclosed drawings, wherein

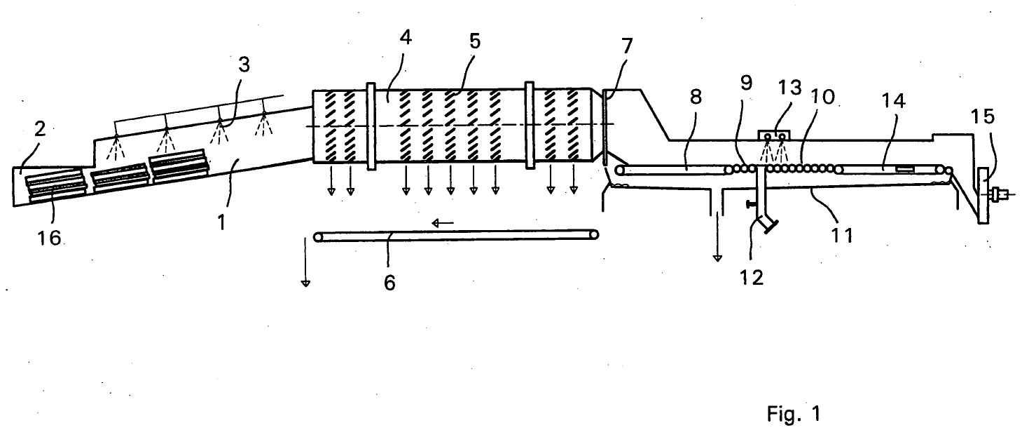

FIG. 1 shows a traditional debarking process,

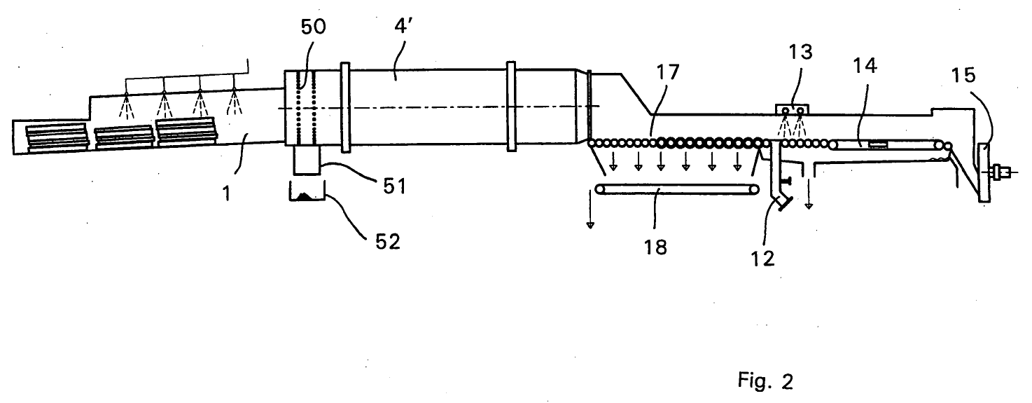

FIG. 2 shows a debarking process employing a debarking drum without bark slots,

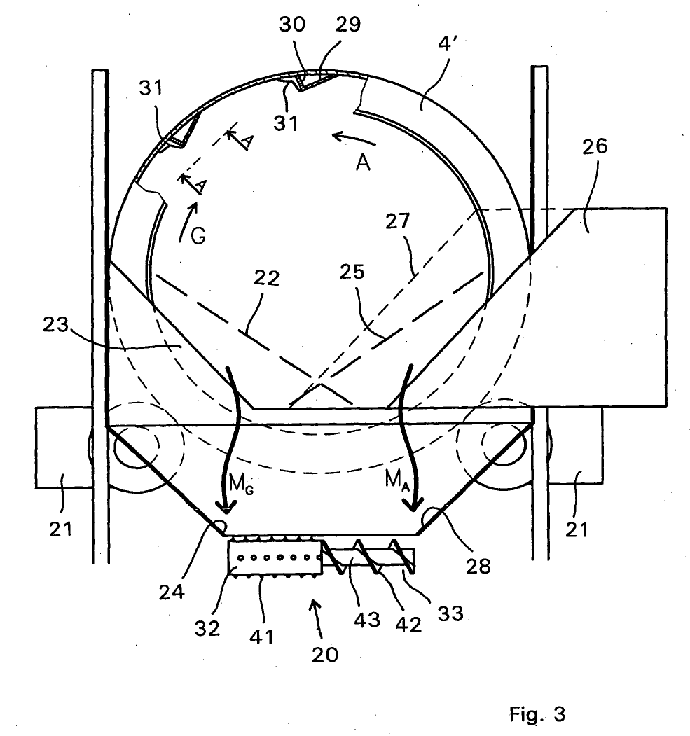

FIG. 3 shows a drum and a discharge conveyor of the drum of one debarking apparatus in accordance with the present invention, viewed towards the discharge opening of the drum,

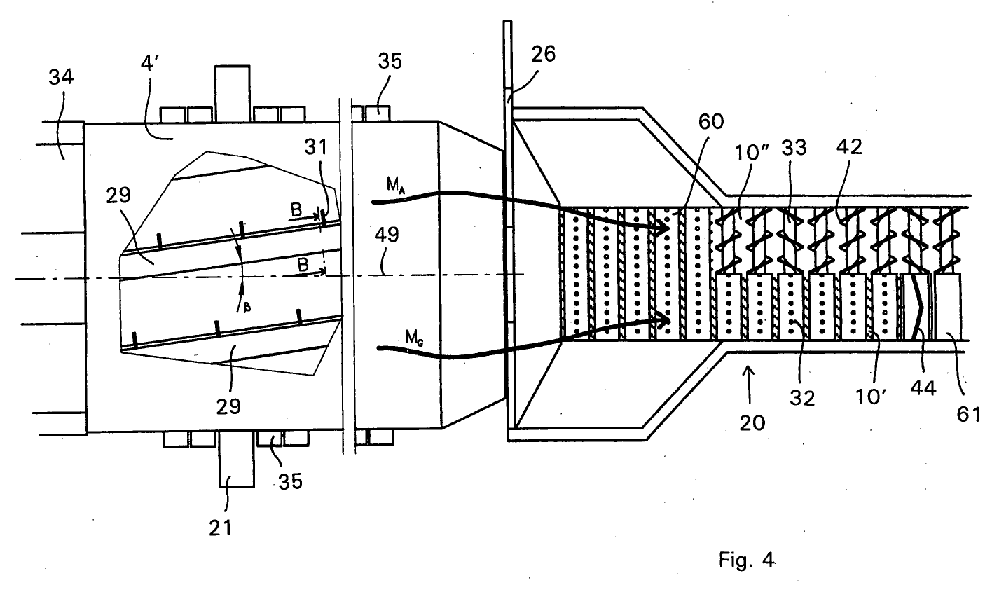

FIG. 4 shows one debarking apparatus of the present invention as a top view,

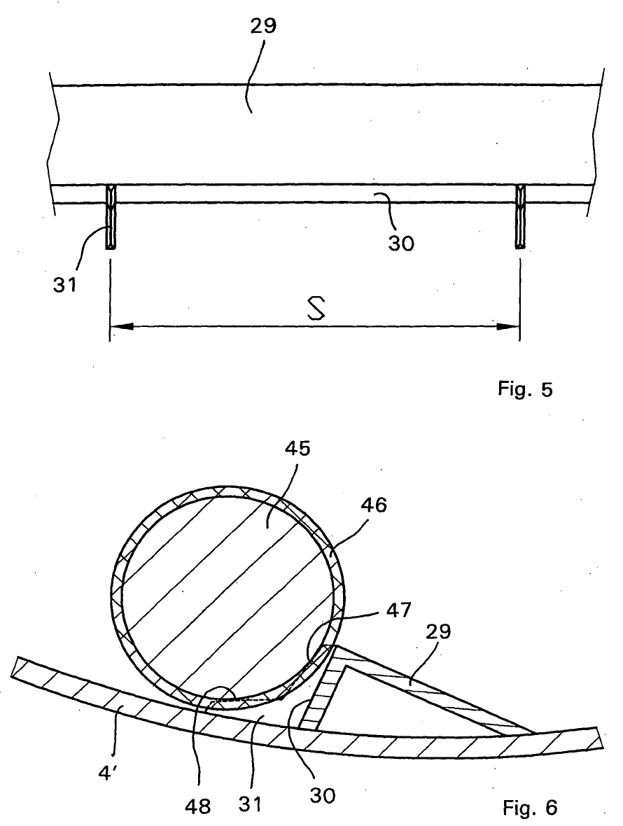

FIG. 5 shows a barking tool mounted inside the drum at section A-A of FIG. 3, and

FIG. 6 shows the barking tool at section B-B of FIG. 4.

FIG. 1 shows a typical debarking process used for example in the Nordic countries. Logs to be debarked 16 are loaded to the loading part 2 of the infeed conveyor 1 of the drum. In wintertime the logs 16 are watered with heated water jets 3 arranged above the infeed conveyor. The conveyor 1 feeds the logs with even speed to the debarking drum 4. The drum 4 inclined slightly in the proceeding direction of logs is rotating relatively slowly. Caused by the rotating motion, the logs mixed inside the drum 4 strike and rub against each other making the bark to loosen from the surface of the logs. With softwood logs the most of the bark drop through the bark slots 5 having a width from 50 to 60 mm and a length of about 500 mm, along bark chutes onto the bark conveyor 6 under the drum.

The logs are discharged from the drum over a gate 7 to a discharge conveyor 8 of the drum. That is followed by a roller conveyor 9, where the rest of the bark pieces are separated from the wood flow.

The loose bark pieces drop through the gaps 10 between the rolls to a water chute 11 transporting the bark pieces further. Also a stone catcher 12 is located on the roller conveyor 9, as well as the washing station 13 of the logs prior to the chipping. The roller conveyor is followed by an infeed conveyor 14 of the chipper, feeding the logs to be chipped to the chipper 15. The water chute 11 is extended below each conveyor 8, 9 and 14, because some amounts of bark and wood pieces fall from the conveyors and between them.

FIG. 2 shows a debarking apparatus in accordance with patent publication WO 03/106125 having a nearly closed drum 4′. On the first end of the drum there are round openings 50 having a diameter of about 50 mm, through which small stones drop via guide chutes 51 to a box 52. The bark loosened from the wood travels along with the wood flow to a roller conveyor 17 after the drum. All the bark is separated from the wood flow by means of the efficient roller conveyor 17, from which the bark drops to a bark conveyor 18 below the roller conveyor. Big stones drop to a stone catcher 12. The roller conveyor 17 is longer than that in the traditional debarking method shown in FIG. 1. Neither bark chutes nor bark conveyors are needed under the drum 4′ having no bark slots, so that the drum can be disposed at a lower elevation.

In the debarking process in accordance with FIG. 1 or 2, different wood species and wood qualities are debarked and the bark is separated with the same apparatus. The only adjustment options are the capacity, the filling degree of the drum and the speed of rotation.

Logs to be debarked in one and the same drum can for example have the following characteristics:
Bark loosens easily as small pieces/bark loosens easily but is long and stringy,
Bark loosens easily being flexible and stringy/bark loosens easily but is thick and inflexible,
Bark loosens easily as small pieces/debarking is quite difficult and the bark loosens as rather big pieces and
Debarking is quite difficult and the bark loosens as small pieces/debarking is easy but the bark loosens as big pieces.

The debarking drum 4′ of the debarking process in accordance with the present invention is illustrated in FIG. 3 in the direction towards the discharge opening, whereby also the cross section of the discharge conveyor 20 following the drum can be seen. The drum there is the debarking drum 4′ of FIG. 2. The roller conveyor 20 operates as a discharge conveyor, the rolls thereof including roll portions 32 with small roll gaps and roll portions 33, where big gaps are formed between the rolls, said rolls being disposed at the opposite ends of one shaft, respectively. The drum 4′ is equipped with driving devices 21 enabling the rotation of the drum in both directions G and A. When a gentle debarking G is needed for easily peelable logs (for example pine), where the bark loosens as relatively small pieces and is therefore easily removed through the roll portion 32 with small slots, the drum 4′ is rotated in the direction G. When logs are debarked that are more difficult to debark and where the loosened bark pieces are bigger, longer and stringier and not easily removed through the slots between the rolls, a more aggressive debarking is needed, and the drum 4′ is rotated in the direction A.

When the drum 4′ is rotated in the direction G, the logs in the drum form an inclined surface about according to the dashed line 22. The logs, the bark and eventual pieces of wood are removed from the drum to the discharge conveyor 20 over the end plate 23. The end plate is fixed, because there is no need to increase the degree of admission of the drum when the wood is easily debarked. The debarking time should be as short as possible in order to avoid breakage of the wood and wood losses. The material (arrow M_{G}) discharged from the drum 4′ drops substantially onto the edge 24 of the discharge conveyor. Because the logs are mainly guided by means of the edge 24 to the portion 32 of the roller conveyor, the eventual broken wood pieces cannot drop between the rolls 32 together with the smaller bark pieces.

When the drum 4′ rotates in the direction A, the logs in the drum form correspondingly an inclined surface according to the dashed line 25. The logs, eventual woos pieces and bigger bark pieces are removed from the drum to the discharge conveyor over the end plate, in other words, gate 26. The position of the gate 26 and, thus, the degree of admission of the drum, can be adjusted. This is necessary for changing the debarking efficiency according to the raw material to be debarked. The gate is illustrated in a more closed position with dashed line 27. The material to be discharged from the drum (arrow M_{A}) falls substantially to the edge 28 of the discharge conveyor guiding the wood and bark flow to the portion 33 of the roller conveyor 20. Through the bigger gaps between the rolls of the portion 33 also bigger bark pieces can fall off.

According to FIGS. 3, 4, 5 and 6, the drum is equipped with barking tools 29 in the form of an angle-bar with different leg lengths (L-bar), operating traditionally as elements for lifting the log pile when the drum 4′ is rotating. The form of the angle-bar 29 is such, that during the more aggressive debarking (direction A), the bar lifts the logs more efficiently than in the more gentle debarking G. In the more aggressive debarking, the surface 30 of the angle-bars lifting the logs and being formed of the steep short leg of the L-formed element can additionally be provided with sharp edged bark cutting tools 31. The purpose of the cutting tools 31 is to break the bark surface of the logs and to cut the bark into shorter pieces so as to have the bark better removed between the rolls 33.

In the more gentle debarking, with the direction of rotation G, the cutting tool 31 stays behind the barking tool 29 thus not damaging the logs. So, the cutting tool 31 acts only in one direction. The operation in accordance with the invention can also be implemented without cutting tools 31, whereby the difference in the effect of the rotation direction G and A to the debarking is smaller.

FIGS. 5 and 6 illustrate the disposition of the bark cutters 31. The suitable distance S between them is at the first end of the drum about from 1 to 2 meters. The cutting tool 31 is formed so that it touches a big log 45 having thick bark at two points 47 and 48. FIG. 6 illustrates, how the cutting tool 31 has cut at its points 47 and 48 the bark 46 of the log 45.

The forepart of the discharge conveyor 20 of FIGS. 3 and 4 is formed of long conveying spiked rolls 60 and of two-part rolls after that for separating the bark. The portion 32 of the second half is formed of cylinders equipped with spikes 41 or ribs 44. Also smooth cylinders 61 can be used. The portion 33 of the second half is formed of cylinders or shafts with a smaller diameter, having for example flanges or threads 42 on their surface. Portions 32 form a more enclosed part of the conveyor, where the gaps between the adjacent rolls for separating the bark are small. Typically, the shortest distance from the cylinder surface of a roll to the surface of an adjacent roll is from 20 to 40 mm. The gap is chosen according to the wood species to be debarked on the plant, as well as according to the size of the potential wood pieces to be separated from the bark. Even a relatively small gap is sufficient for pinewood, because the surfaces of the rolls are moving, and in this way the wood losses for the part of the debarking drum can be clearly decreased compared with the wood losses caused by bark slots having a width from 50 to 60 mm.

The pitch of the blades 42 of the threads in the rolls 33 of the roller portion used for the more aggressive debarking is of the range from 150 to 400 mm. This is to prevent the long logs from falling between the rolls. The distance between the surfaces of the adjacent cylinders 43 ranges from 50 to 300 mm. Due to the bigger gap 10″ the long bark pieces are efficiently separated from the wood flow in this portion 33 of the conveyor. In FIG. 4, the gaps 10″ between the rolls have been highlighted for the purpose of clarifying. The threads 42 of the rolls 33 move the wood and bark flow efficiently back and forth in the lateral direction, intensifying the separating of the bark from the wood flow. A disadvantage is also, that the smaller wood pieces drop through the gaps 10″, increasing the wood loss. The construction of the roller conveyor portion 33 is determined, naturally, by the type of the bark. The inventive idea of the roller conveyor is that the portions 32, 33 of the roller conveyor have their structural difference in bark separating performance and the incurred wood losses.

In the method in accordance with the invention, wherein the material is discharged from the drum according to the direction of rotation of the drum onto a roller conveyor having two portions, both a closed drum and a traditional drum with bark openings can be used.

FIG. 4 shows an infeed conveyor 34 of a drum, a debarking drum 4′, support 35 and driving elements 21 of the drum, an adjustable gate 26 and a discharge conveyor 20 of the drum, as a top view. Through the section in the drum 4′ also barking tool bars 29 can be seen on the bottom of the drum. The bars round the inner track of the drum as spirals, in other words, the bars are disposed at an angle β with respect to the direction of the axis 49 of the drum. Preferably the angle is from 5° to 30°. By means of the barking tool bars disposed as spirals, the proceeding of the material flow in the drum can be speeded up or retarded. Having the spiral form as shown in FIG. 4, the bars 29 speed up the proceeding of the wood flow through the drum, when the drum is rotating in the direction G. If the wood is especially easy to debark, it is favourable to shorten the debarking time, because that decreases the wood losses. When the drum is rotated in the direction A, the bars 29 retard the proceeding of the wood in the drum thus increasing the debarking time.

A debarking process in accordance with the invention can be used in a plant, where wood species with different debarking properties are debarked. The wood being more difficult to debark is debarked aggressively and the wood being more easily debarked is debarked gently on the same debarking line. An advantage of the invention is also the fact that the effect and aggressiveness of the debarking of the wood can be dimensioned according to the need and in that way unnecessary wood losses can be avoided.

Instead of the roller conveyor 20, also some other apparatus or device combination can be used, having different functions with respect to the different portions of the apparatus for separating wood and bark.

1. Drum debarking method for wood, wherein the bark is loosened from the wood in a debarking drum being alternatively rotatable in the opposite directions and having different debarking properties in said alternative rotation directions, wherein the wood and the loosened bark along with the wood are guided to bark separation dependent on the rotation direction of the drum.

2. A method in accordance with claim 1, wherein the wood and the bark loosened from it are guided to a conveyor having different bark separating properties in the different halves thereof.

3. A method in accordance with claim 2, wherein a roller conveyor is used, the rolls of which have different roll structures on the opposite halves of the conveyor.

4. An apparatus for debarking wood, said apparatus comprising a debarking drum (4′), means for feeding the wood material to be debarked to the drum, means for rotating the drum alternatively in the opposite directions (G; A) about the longitudinal axis of the drum, means (29, 30, 31) inside the debarking drum (4′) for providing a debarking effect being dependent on the direction of rotation of the drum, as well as devices (17) for separating the debarked wood and the loosened bark along with it, wherein the separating devices (17) of the loosened bark comprise a conveyor having different bark separating properties in the different sides of the conveying direction thereof.

5. An apparatus in accordance with claim 4, wherein the separating elements (17) of the loosened bark are comprised of a roller conveyor with rolls, each roll having on one side (32) of the conveyor a different circumferential construction than on the opposite side (33) of the conveyor.

6. An apparatus in accordance with claim 5, wherein the different bark separation properties of the different sides of the conveyor are provided by means of different gaps between the rolls.

7. An apparatus in accordance with claim 4, wherein the side of the bark separation elements (17) having a more efficient separation function is located to the discharge side of the direction of rotation (A) of the debarking drum (4′) having more efficient debarking properties.

8. An apparatus in accordance with claim 4, wherein the debarking drum (4′) substantially has a closed casing.

9. An apparatus in accordance with claim 4, wherein the casing of the debarking drum (4′) is equipped with bark removal slots.

10. An apparatus in accordance with claim 5, wherein the debarking drum (4) substantially has a closed casing.

11. An apparatus in accordance with claim 6, wherein the debarking drum (4) substantially has a closed casing.

12. An apparatus in accordance with claim 7, wherein the debarking drum (4) substantially has a closed casing.

13. An apparatus in accordance with claim 5, wherein the casing of the debarking drum (4′) is equipped with bark removal slots.

14. An apparatus in accordance with claim 6, wherein the casing of the debarking drum (4′) is equipped with bark removal slots.

15. An apparatus in accordance with claim 7, wherein the casing of the debarking drum (4′) is equipped with bark removal slots.
